(19) United States
(12) Patent Application Publication
(10) Pub. No.: US 2021/0396917 A1
(43) Pub. Date: Dec. 23, 2021

(54) ANTI-GLARE DIFFUSING FILM FOR ELECTRONIC DISPLAYS

(71) Applicant: HEWLETT-PACKARD DEVELOPMENT COMPANY, L.P., SPRING, TX (US)

(72) Inventors: KUAN-TING WU, TAIPEI CITY (TW); HANG YAN YUEN, SPRING, TX (US); HUI HE, SPRING, TX (US)

(21) Appl. No.: 17/418,450

(22) PCT Filed: Feb. 1, 2019
(86) PCT No.: PCT/US2019/016247

§ 371 Date: Jun. 25, 2021

(51) Int. Cl. G02B 5/02; C09D 167/02; B33Y 70/10; B33Y 80/00; B32B 7/12; B32B 5/16

(52) U.S. Cl. CPC G02B 5/0242; C09D 167/02; G02B 5/0278; B32B 2457/208; B33Y 80/00; B32B 7/12; B32B 5/16; B33Y 70/10

(57) ABSTRACT

The present disclosure is drawn to anti-glare diffusing films for electronic displays. In one example, an anti-glare diffusing film for an electronic display can include multiple fused layers that individually include transparent polymer particles fused together using a fusing agent. The fusing agent can include diffusing particles selected from hollow glass beads, hollow polymer beads, titanium aerogel particles, or a combination thereof.

### BACKGROUND

The use of personal electronic devices, computing devices, or any other type of device that uses an optical display continues to increase. Televisions, desktop computers, laptops, tablets, smartphones, and the like, with optical display screens have become more and more common. Touchscreen tablet computers and particularly touchscreen smartphones have become ubiquitous in many countries. Portable laptop computers continue to be used by many for personal, entertainment, and business purposes, and there is increasing demand for these and other devices with touchscreens and/or other types of display screens that can provide clarity and high resolution.

### BRIEF DESCRIPTION OF THE DRAWING

FIG. 1 is a cross-sectional view illustrating an example anti-glare diffusing film in accordance with the present disclosure;

FIG. 2 is a cross-sectional view illustrating another example anti-glare diffusing film in accordance with the present disclosure;

FIG. 3 is a cross-sectional view illustrating an example electronic display in accordance with the present disclosure;

FIG. 4 is a cross-sectional view illustrating another example electronic display in accordance with the present disclosure;

FIG. 5 is a cross-sectional view illustrating yet another example electronic display in accordance with the present disclosure;

FIG. 6 is a schematic diagram of an example 3D printing kit in accordance with the present disclosure;

FIG. 7 is a schematic diagram of another example 3D printing kit in accordance with the present disclosure; and

FIGS. 8A-8D are cross sectional schematic views illustrating an example method of making an example anti-glare diffusing film in accordance with the present disclosure.

### DETAILED DESCRIPTION

The present disclosure describes anti-glare diffusing films for electronic displays. In one example, an anti-glare diffusing film for an electronic display can include multiple fused layers that individually include transparent polymer particles fused together using a fusing agent. The fusing agent can include diffusing particles selected from hollow glass beads, hollow polymer beads, titanium aerogel particles, or a combination thereof. In another example, the anti-glare diffusing film can have a thickness from about 50 μm to about 500 μm. In yet another example, the transparent polymer particles can include polyethylene terephthalate, polyethylene naphthalate, polycarbonate, polyethersulfone, polycyclic olefin, polyimide, polarylate, polymethyl methacrylate, copolymers thereof, or combinations thereof. In a further example, the individual fused layers can include a relatively higher concentration of the diffusing particles in a top portion of the individual fused layers and a relatively lower concentration of the diffusing particles in a bottom portion of the individual fused layers. In certain examples, a concentration of the diffusing particles can be uniform across the anti-glare diffusing film. In an alternate example, the concentration of the glass beads, hollow polymer beads, or titanium aerogel particles can be higher in an area to be located over a relative bright spot in the electronic display and lower in an area to be located over a relative dark spot in the electronic display.

The present disclosure also extends to electronic displays. In one example, an electronic display can include a display panel, an optically clear adhesive layer over the display panel, and an anti-glare diffusing film over the adhesive layer. The anti-glare diffusing film can include multiple fused layers that individually include transparent polymer particles fused together using a fusing agent. The fusing agent can include diffusing particles selected from hollow glass beads, hollow polymer beads, titanium aerogel particles, or a combination thereof. In other examples, the display panel can be a liquid crystal display (LCD) panel, a light emitting diode (LED) panel, or an organic light emitting diode (OLED) panel. In a further example, the display can include a backlight unit having a relative bright spot of illumination, and a concentration of the diffusing particles in the anti-glare diffusing film can be higher in an area over the relative bright spot compared to other areas of the anti-glare diffusing film with relative darker illumination. In another example, the electronic display can also include a touch sensor layer over the display panel and below the anti-glare diffusing film. In further examples, the transparent polymer particles can include polyethylene terephthalate, polyethylene naphthalate, polycarbonate, polyethersulfone, polycyclic olefin, polyimide, polarylate, polymethyl methacrylate, copolymers thereof, or combinations thereof

The present disclosure also extends to 3D printing kits. In one example, a 3D printing kit can include a powder bed material including transparent polymer particles, and a fusing agent to apply to the powder bed material. The fusing agent can include diffusing particles selected from hollow glass beads, hollow polymer beads, titanium aerogel particles, or a combination thereof. In further examples, the transparent polymer particles can include polyethylene terephthalate, polyethylene naphthalate, polycarbonate, polyethersulfone, polycyclic olefin, polyimide, polarylate, polymethyl methacrylate, copolymers thereof, or combinations thereof. In another example, the 3D printing kit can also include a detailing agent that includes a detailing compound. In yet another example, the fusing agent further can also include a colorless infrared absorbing compound.

The anti-glare diffusing films, the electronic displays, and the 3D printing kits will be described in greater detail below. It is also noted that when discussing these various examples described herein, relative discussions for individual examples can be considered applicable to the other examples, whether or not they are explicitly discussed in the context of that example. Thus, for example, in discussing hollow glass bead related to the anti-glare diffusing films, such disclosure is also relevant to and directly supported in the context of the electronic displays and/or 3D printing kits, and vice versa.

### Anti-Glare Diffusing Films

Many popular personal electronic devices include electronic displays. Computer monitors, laptops, tablet computers, smartphones, and a variety of other devices include display screens. In particular these devices include display screens that include built in lighting such as back lighting or edge lighting. Several display panel technologies are currently in use, such as liquid crystal display (LCD), light emitting diode (LED), organic light emitting diode (OLED), and others.

The present disclosure describes anti-glare diffusing films that can be used with these types of electronic displays. Glare on electronic displays can be cause by light reflecting from light sources such as sunlight, windows, indoor lights, and so on. This glare can often be distracting to users of electronic devices and make it difficult to see information displayed by the electronic devices. In some examples, the anti-glare diffusing films described herein can be added to or incorporated in electronic displays to reduce glare caused by other light sources.

In some examples, an anti-glare diffusing film for an electronic display can include multiple fused layers that individually include transparent polymer particles fused together using a fusing agent. The fusing agent can include diffusing particles selected from hollow glass beads, hollow polymer beads, titanium aerogel particles, or a combination thereof. In certain examples, the particular structure of this anti-glare film can be formed by using an additive manufacturing process in which the fusing agent is applied to a layer of transparent polymer particles and then the layer is heated to cause the particles to melt and coalesce. The fusing agent can include the hollow glass beads, hollow polymer beads, or titanium aerogel particles. These beads and particles can collectively be referred to as diffusing particles. When the fusing agent is applied to the transparent polymer particles, the diffusing particles can be dispersed in spaces between the transparent polymer particles. The diffusing particles can then be embedded in the film when the transparent polymer particles are melted, coalesce, and form a polymer film. To produce an anti-glare diffusing film of a desired thickness, the process of applying the fusing agent to a layer of transparent polymer particles and then causing the polymer particles to form a film can be repeated multiple times to form multiple layers. After one layer of polymer particles has been melted to form a film, a new layer of loose polymer particles can be spread over the film. The fusing agent can then be applied and the new layer of particles can be melted to form a second layer of the film. The second layer of the film can fuse to the first layer during the melting process. This can be repeated any number of times to build up an anti-glare diffusing film made of multiple fused layers.

The diffusing particles—including hollow glass beads, hollow polymer beads, and/or titanium aerogel particles—can reduce glare by diffusing light that is reflected off the electronic display. In this way, instead of a distracting reflection on the electronic display, the anti-glare diffusing film can reflect diffused light in many directions without interfering with the viewability of the electronic display. In some examples, the diffusing effect of the diffusing particles can be due to a difference in refractive index between the particles and the transparent polymer film in which the particles are embedded. When hollow glass beads or hollow polymer beads are used, the diffusing effect can also be due to the difference in refractive index between the glass or polymer shell of the beads and the air or other material in the center of the beads.

Another feature of the anti-glare diffusing films described herein is that the distribution of the diffusing particles in the film can be controlled and customized. In some examples, the fusing agent can be applied to the transparent polymer powder by a printing process that can allow control over how much fusing agent is applied to individual areas of the transparent polymer particle layer. In certain examples, the fusing agent can be jetted onto the layer of polymer particles by a printhead such as a thermal jetting printhead. The printhead can be programmed to jet any amount of fusing agent (or fusible compound carried therein) onto any area of the polymer particle layer. Thus, if more diffusion is desired in a certain area then the printhead can jet more of the fusing agent in that area. This results in a greater concentration of diffusing particles in that area of the film that is formed.

In some cases, controlling the concentration of diffusing particles in specific areas of the anti-glare diffusing film can be useful for ameliorating uneven brightness in the electronic display. Many electronic displays use either edge lighting or back lighting. In edge-lit displays, a light source is located at an edge of the display. A waveguide is often used to direct light from the edge light and project the light forward through the display panel at various locations across the area of the panel. In back-lit displays, multiple light sources are located behind the display panel. In both back-lit and edge-lit displays, the distribution of light across the panel is often non-uniform. Displays often have bright spots in some locations and dim spots in other locations, making the brightness of the display appear uneven. However, the anti-glare diffusing films described herein can be custom designed to reduce the non-uniformity of brightness of an electronic display. For example, if a particular electronic display has a bright spot in a certain location, then the anti-glare diffusing film may be designed to have a higher concentration of diffusing particles in the same location. The diffusing particles can help to even out the brightness of the display at the bright spot. Thus, in some examples, the anti-glare diffusing films described herein can enhance the uniformity of brightness of the electronic display while also preventing glare from external light sources. As described herein, “bright spots” and “dark spots” can be referred to as “relative” bright spots and dark spots, indicating that their brightness due to illumination can be “bright” and “dark” relative to one another, rather than with absolute illumination intensities. Thus, the anti-glare diffusing films here can be used to even out relative bright spots compared to relative dark spots (of illumination) compared to one another to provide a more even illumination across a display, for example.

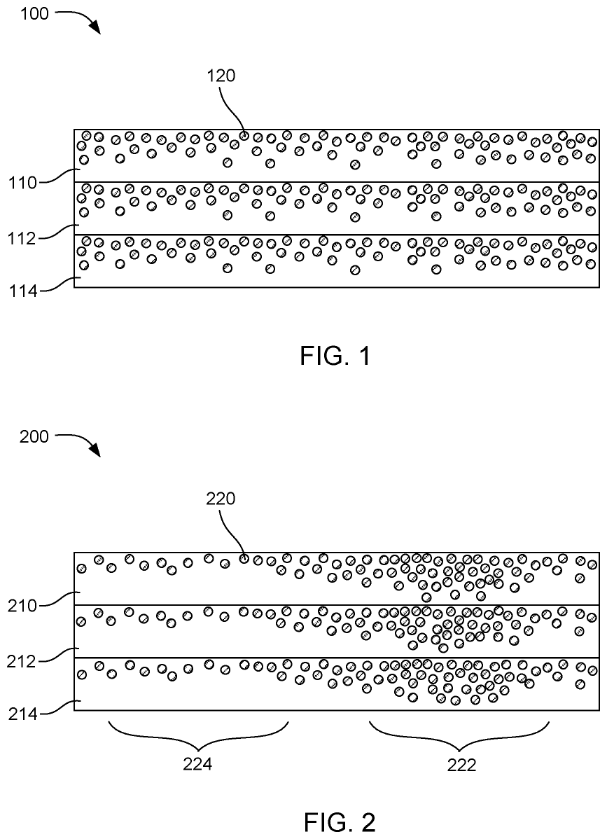

With this description in mind, FIG. 1 shows a cross-sectional view of an example anti-glare diffusing film 100 for an electronic display. The film includes multiple fused layers 110, 112, 114 of fused transparent polymer particles. The transparent polymer particles in this example have fused together completely to form solid layers of transparent polymer. The individual layers can also include diffusing particles 120 embedded in the transparent polymer. The diffusing particles can include hollow glass beads, hollow polymer beads, and/or titanium aerogel particles. As explained above, the diffusing particles can be introduced by applying a fusing agent to the transparent polymer particles before fusing the particles together. The location and distribution of the diffusing particles can depend on the amount of fusing agent (or fusible compound carried therein) that was printed on specific locations across the layer of transparent polymer particles. In this example, the concentration of diffusing particles is roughly uniform across the area of the individual layers. However, as shown in the figure, the diffusing particles in this example tend to remain near the top surface of individual layers of transparent polymer particles and then the diffusing particles become embedded closer to the top surface of the layers on average when the transparent polymer particles are fused together. This can be due to the difficulty of making the diffusing particles penetrate into the spaces between the transparent polymer particles. Although some diffusing particles penetrate part way through the layer of transparent polymer particles, most of the diffusing particles come to rest somewhere nearer to the top of the layer. In the final diffusing film shown in FIG. 1, the layers of transparent polymer have a relatively higher concentration of diffusing particles in a top portion of the layers and a relatively lower concentration of the diffusing particles in a bottom portion of the layers.

The anti-glare diffusing films described herein can be manufactured and used in a variety of orientations, and therefore spatial terms such as “top,” “bottom,” “upper,” “lower,” “above,” “below,” and so on are not to be construed as limiting the anti-glare diffusing films to any particular orientation. Rather, these terms are used for convenience in describing features of the anti-glare diffusing films. As explained above, in some examples the individual fused layers can have a relatively higher concentration of diffusing particles in a top portion of the layers. In this context, the term “top” is used because in some examples the layers can be formed by applying fusing agent from above onto a horizontal layer of transparent polymer particles. Thus, the fusing agent is applied to the top of the layers and a higher concentration of diffusing particles can remain near the top of the layer. When the anti-glare diffusing film is installed on an electronic display, the film may be oriented differently. For example, if the anti-glare diffusing film is installed on a computer monitor then the “top” surface of the fused layers may actually be a front surface (i.e., facing toward a viewer) or a back surface (i.e., facing away from a viewer) of the film depending on how the film was installed on the computer monitor.

FIG. 2 shows another example anti-glare diffusing film 200. This example also includes multiple fused layers 210, 212, 214 of fused transparent polymer particles. Diffusing particles 220 are embedded in the layers as in the previous example. However, in this example, the concentration of diffusing particles is not constant across the film. Instead, the film has a higher concentration of diffusing particles in a first area 222 and a lower concentration of diffusing particles in a second area 224. In some examples, the higher concentration of diffusing particles may be designed to be in an area over a bright backlight or other bright spot on an electronic display so that the diffusing particles can make the brightness of the display more uniform.

The anti-glare diffusing films described herein can generally be flexible thin films that can either be applied to an existing electronic display or integrated into an electronic display as part of the manufacture of the electronic display. In certain examples, the anti-glare diffusing film can be designed to apply to an existing electronic display. The dimensions of the anti-glare diffusing film can be selected to match the dimensions of the display. In various applications, the anti-glare diffusing film may have a length and width individually from about 5 cm to about 500 cm to fit the size of the display. In further examples, the anti-glare diffusing film can have a thickness from about 50 μm to about 500 μm. In still further examples, the anti-glare diffusing film can have a thickness from about 75 μm to about 400 μm, or from about 100 μm to about 300 μm.

In some other examples, the anti-glare diffusing film can include an adhesive layer on a surface of the film so that the film can be adhered to an electronic display. In some examples, the adhesive layer can have a thickness from about 1 μm to about 100 μm, from about 2 μm to about 50 μm, or from about 5 μm to about 30 μm. Non-limiting examples of adhesive materials that can be used include ethylene vinyl acetate copolymers, ethylene ethyl acrylate copolymers, ionomers, poly(ethyl acrylate), phenoxy resins, polyamides, polyesters, polyvinyl acetate, polyvinyl butyral, polyvinyl ethers, and others

In some examples, the anti-glare diffusing film can include a removable release liner on the bottom face of the adhesive layer. The release liner can be peeled off before adhering the anti-glare diffusing film to an electronic device. In some examples, the release liner can include a transparent plastic film, such as a polyethylene terephthalate (PET) film or a polycarbonate (PC) film, for example. In some examples, the release liner can be siliconized by coating a surface of the film with a silicone compound. In another example, the release liner can be siliconized paper.

### Electronic Displays

The anti-glare diffusing films described above can be adhered to or incorporated into electronic displays. In some examples, the anti-glare diffusing films can include an adhesive layer so that the films can be adhered to an electronic display. In other examples, a permanent adhesive can be used during manufacture of the electronic display to attach an anti-glare diffusing film to the display. In certain examples, the anti-glare diffusing film can be located on the viewer side surface of the electronic display. Thus, although the electronic display can include multiple different layers, in some examples the anti-glare diffusing film can be the outermost layer (i.e., closest layer to the viewer). Thus, the anti-glare diffusing film can be in a suitable position to reduce glare caused by light reflecting off the outermost layer of the electronic display.

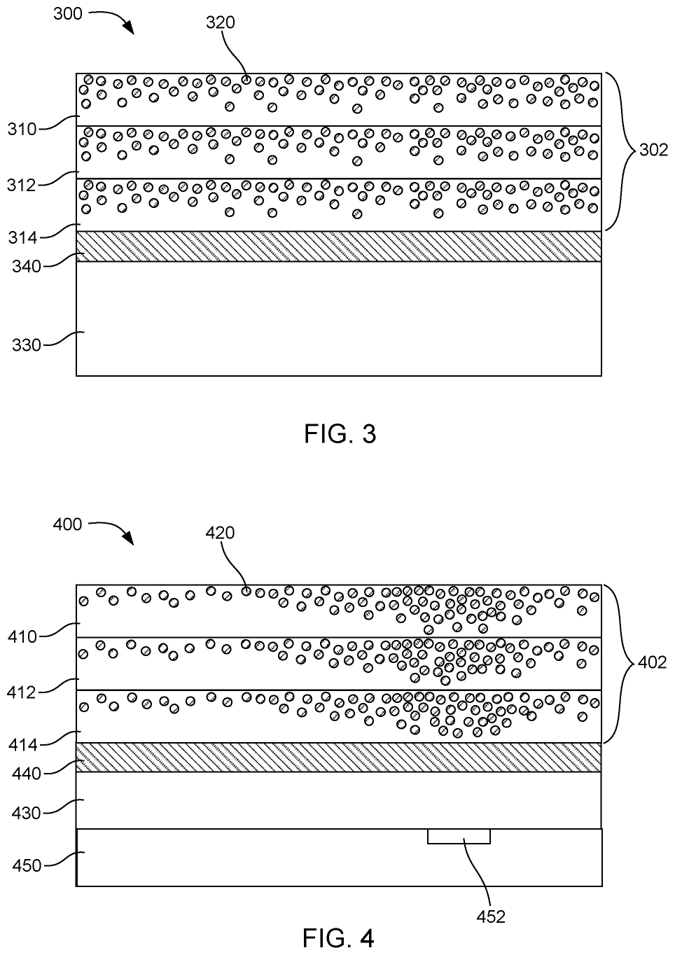

FIG. 3 shows a cross-sectional view of an example electronic display 300 in accordance with examples of the present disclosure. The electronic display includes a display panel 330, an optically clear adhesive layer 340 on the surface of the display panel, and an anti-glare diffusing film 302 over the adhesive layer. The anti-glare diffusing film includes multiple fused layers 310, 312, 314 that individually include transparent polymer particles fused together using a fusing agent including diffusing particles 320. The diffusing particles are hollow glass beads, hollow polymer beads, or titanium aerogel particles.

FIG. 4 shows a cross-sectional view of another example electronic display 400 in accordance with examples of the present disclosure. In this example, the display panel includes a backlight unit 450 that includes a light emitting diode 452. The backlight unit is located under the display panel 430 to shine light through the display panel. This example also includes an anti-glare diffusing film 402 over an adhesive layer 440 over the display panel. The anti-glare diffusing film includes multiple fused layers 410, 412, 414 of transparent polymer particles fused together with diffusing particles 420 embedded in the layers. In this example, the concentration of the diffusing particles was controlled so that there is a higher concentration of diffusing particles in the area over the light emitting diode of the backlight unit. The higher concentration of diffusing particles in this area can diffuse the light from the light emitting diode. Without the anti-glare diffusing in this example, the light emitting diode would cause a bright spot on the display. The high concentration of diffusing particles in the anti-glare diffusing film over the light emitting diode can help to make the brightness of the display more uniform.

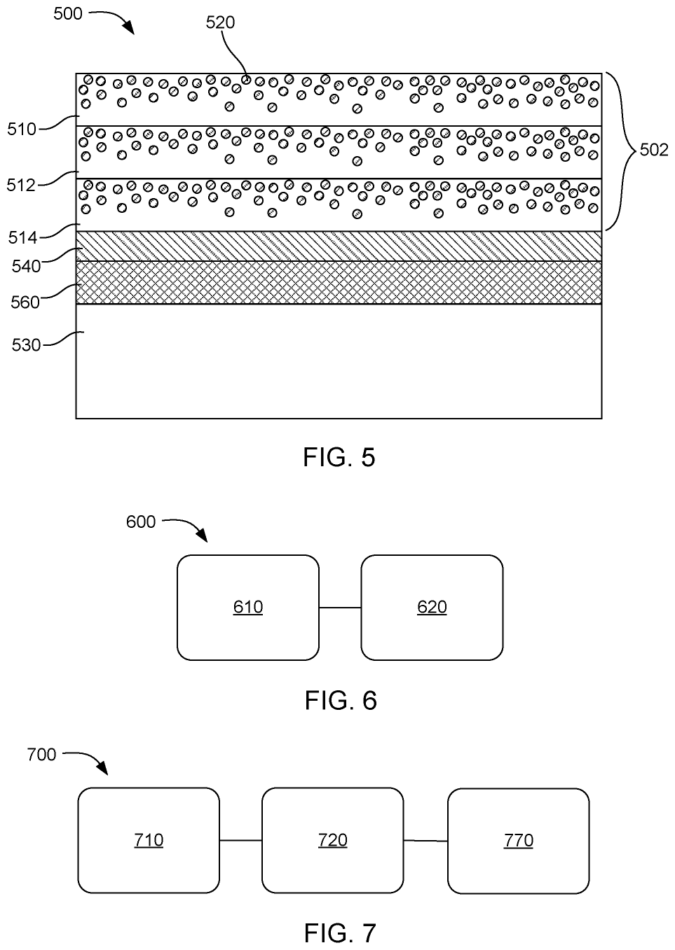

In further examples, additional layers can be included in the electronic display. Many electronic displays for personal electronic devices can include a touch sensor layer. This is a transparent layer that can detect touch of a finger or stylus to allow for interaction with the electronic device. FIG. 5 shows a cross-sectional view of another example electronic display 500 in accordance with examples of the present disclosure. This example includes a display panel 530 having a touch sensor 560 over the display panel. An adhesive layer 540 and an anti-glare diffusing film 502 are placed over the touch sensor. The anti-glare diffusing film includes multiple fused layers 510, 512, 514 that are individually made up of fused transparent polymer particles with diffusing particles 520 embedded in the layers. In this example, the touch sensor is located over the display panel and beneath the anti-glare diffusing film. Therefore, the touch sensor can be sufficiently sensitive to register touch input through the anti-glare diffusing film.

Touchscreen touch sensors come in a wide variety of types, some which work with user finger input, others are designed for input using a stylus, and some allow for both types of input, e.g., finger, stylus, or other device. As a note, many touchscreen technologies include multiple layers, but as shown and described herein, the touch sensor is shown as a single layer. Thus, no attempt has been made to show the various layers that may be present in various touchscreen technologies, as it is understood that the component as a whole, as shown in FIG. 5, is considered to be a touch sensor that may include multiple layers.

Examples of touchscreen technologies that can be used with the electronic displays described herein can include, without limitation, resistive touchscreens; surface acoustic wave (SAW) touchscreens; capacitive touchscreens, e.g., surface capacitance, projected capacitance, mutual capacitance, self-capacitance, stylus capacitance, etc.; infrared grid; infrared acrylic projection; optical imaging; dispersive signal technology; acoustic pulse recognition; or the like. In some examples, the touchscreen can be electrically coupled to an electronic device to provide touchscreen accuracy, learning, or logic; consider ergonomics; provide haptics such as vibratory feedback; receive security information such as fingerprint verification; etc. In one example, the touchscreen can include a capacitive touch sensor. In this example, a finger of a user, which is conductive, can be used to create a coupled capacitor with electronics components beneath an outer display surface when a touchscreen display surface is contacted. Thus, a capacitive touch screen can include an image processing controller that continuously images a touch profile of a user. The controller can thus pick up changes in the capacitive value between electronic nodes and drive lines to pinpoint the location or movement of a touch of a display surface. The coordinates detected can then be fed back to the operating system. Though touchscreens with capacitive touch sensors are described above, it is noted that other touchscreen/touch sensor technologies can likewise be used as listed above

In further examples, the display panel can include a LCD panel, LED panel, OLED panel, or another type of display panel. Examples of electronic displays can include desktop computer monitors, laptop monitors, tablet monitors, smartphone monitors, gaming system monitors, television monitors, digital signage monitors, etc. More specific examples of these displays can include a thin film transistor (TFT) LCD; an electroluminescent emitter, e.g., electro-luminescence (EL), light-emitting diode (LED), organic light-emitting diode (OLED), etc.; a photoluminescent emitter, e.g., plasma display panel (PDP); or the like.

In certain examples, an LED display may include an LED backlight, diffuser and/or light guides, polarizing films, liquid crystals, color filters, etc. These assemblies can be referred to collectively as a display panel or the entire electronic display, depending on the components included. An OLED display may include, for example, a substrate, an anode layer or assembly of layers, a conductive layer (e.g., organic molecules or polymer), an emissive layer (e.g., organic molecules or polymer), and a cathode or assembly of cathodes. There may also be other layers as well including anti-reflective film(s), color refiners, endcaps, hole transport layers, electron transport layers, etc.

### 3D Printing Kits

The present disclosure also extends to 3D printing kits included materials for making anti-glare diffusing films using 3D printing processes. In a particular example, the HP Multi Jet Fusion 3D® printing system (HP, Inc., California) can be used to make the anti-glare diffusing films described herein. This system generally uses a powder bed build material and a fusing agent that is jetted onto the powder bed build material. After the fusing agent is printed on an area of the powder bed, the entire powder bed can be exposed to radiation such as infrared light. The fusing agent can absorb more radiant energy compared to the powder that was not printed with the fusing agent. Because of this, the powder that was printed with the fusing agent can heat up to a temperature at which the powder coalesces to form a solid layer.

In one example, a 3D printing kit for use in such a process can include a powder bed material that includes transparent polymer particles and a fusing agent. The fusing agent can include hollow glass beads, hollow polymer beads, titanium aerogel particles, or a combination thereof. FIG. 6 is a schematic diagram of an example 3D printing kit in accordance with examples of the present disclosure. This kit includes transparent polymer powder 610 and fusing agent that includes hollow polymer beads 620.

In further examples, the 3D printing process described above can also utilize a detailing agent. The detailing agent can reduce the temperature of powder bed material onto which the detailing agent is printed. In some examples, fusing agent can be printed onto an area of the powder bed that is desired to be fused together, and the detailing agent can be printed on another area that is not desired to be fused together. In certain examples, the detailing agent can be printed around a perimeter of the area where the fusing agent is printed. Without the detailing agent around the perimeter, in some cases heat from the area printed with the fusing agent can creep into surrounding powder bed material and soften the nearby powder, causing some particles to undesirably stick to the edges of the printed part. The detailing agent can prevent heat from creeping into surrounding powder bed material and thereby give the 3D printed part cleaner edges. In further examples, the detailing agent can be printed on all areas that are not to be fused to ensure that these areas do not reach a high enough temperature to fuse. In other examples, the detailing agent can be printed in the same area where the fusing agent is printed to control the temperature of the area to be fused. In certain examples, some areas to be fused can tend to overheat, especially in central areas of large fused sections. To control the temperature and avoid overheating (which can lead to melting and slumping of the build material), the detailing agent can be applied to these areas

FIG. 7 shows a schematic diagram of another example 3D printing kit 700 in accordance with examples of the present disclosure. This kit includes a powder bed material 710 including transparent polymer particles, a fusing agent 720 including hollow polymer beads, and a detailing agent 770. The detailing agent can include a detailing compound, which can be a component that reduces the temperature of the powder bed material onto which the detailing agent is printed. For example, the detailing compound can be a solvent that can evaporate and evaporatively cool the powder bed material.

In some examples, the 3D printing system can make an anti-glare diffusing film by jetting fusing agent and detailing agent onto the powder bed according to a 3D object model of the anti-glare diffusing film. 3D object models can in some examples be created using computer aided design (CAD) software. 3D object models can be stored in any suitable file format. In some examples, an anti-glare diffusing film as described herein can be based on a single 3D object model. The 3D object model can define the three-dimensional shape of the anti-glare diffusing film. In some examples, the 3D object model can also include information about areas where higher concentrations of the diffusing particles are desired. Thus, based on the 3D object model, the 3D printing system can jet an appropriate amount of fusing agent (including fusible compound therein) onto specific areas of the powder bed. This information may be in the form of a droplet saturation, for example, which can instruct a 3D printing system to jet a certain number of droplets of agent/fluid into a specific area. This can allow the 3D printing system to finely control radiation absorption, cooling, concentration of the diffusing particles, and so on. All this information can be contained in a single 3D object file or a combination of multiple files. The anti-glare diffusing film can be made based on the 3D object model. As used herein, “based on the 3D object model” can refer to printing using a single 3D object model file or a combination of multiple 3D object models that together define the anti-glare diffusing film. In certain examples, software can be used to convert a 3D object model to instructions for a 3D printer to form the anti-glare diffusing film by building up individual layers of build material.

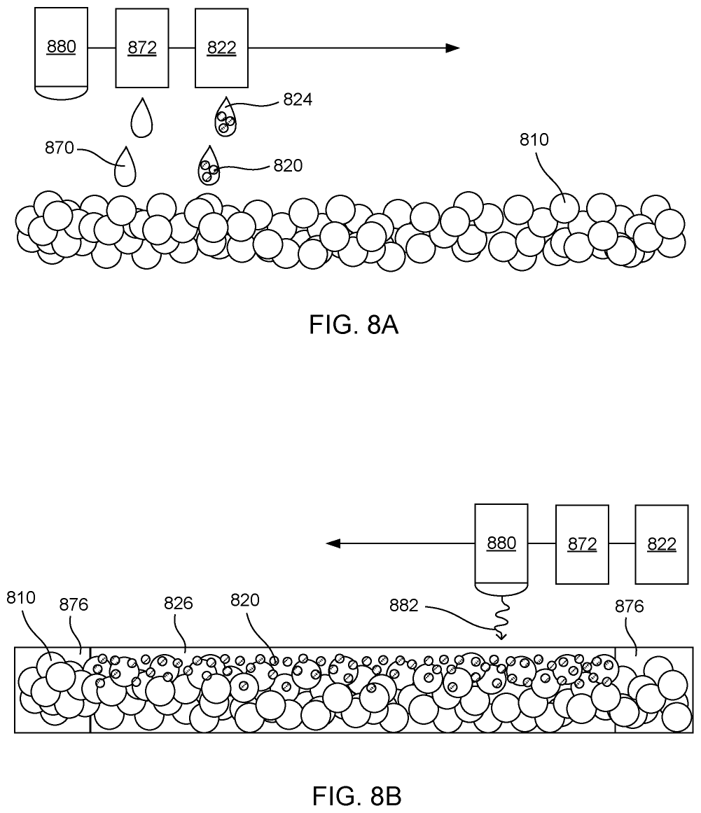

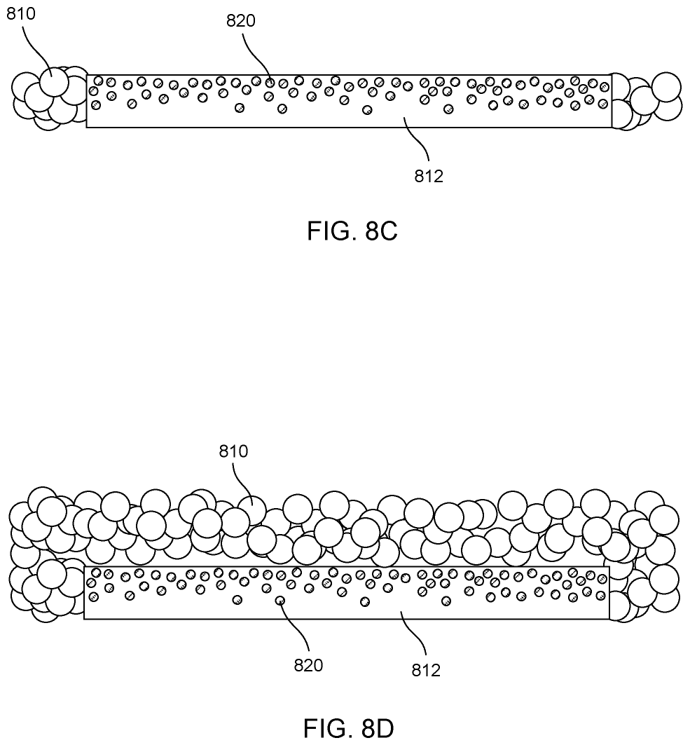

To illustrate the process of 3D printing the anti-glare diffusing film using the 3D printing kits described herein, FIGS. 8A-8C show a schematic view of the formation of a layer of an example anti-glare diffusing film, and FIG. 8D shows the start of a new layer of polymer particles applied thereon. In FIG. 8A, a layer of transparent polymer particles 810 is spread out on a powder bed. A fusing agent printhead 822 jets a fusing agent 824 onto the layer of transparent polymer particles. The fusing agent includes diffusing particles 820. A detailing agent printhead 872 jets a detailing agent 870 onto the layer of transparent polymer particles. As shown in FIG. 8B, the fusing agent is jetted onto a first area 826 of the polymer particles, and the detailing agent is jetted onto a second area 876 of the polymer particles. A radiation source 880 is then used to irradiate the layer of polymer particles with infrared radiation 882. As shown in FIG. 8C, the polymer particles in the area where fusing agent was printed coalesce to form a solid layer 812 with the diffusing particles embedded therein. The area where the detailing agent was printed remains as loose particles. Then, as shown in FIG. 8D, a new layer of polymer particles is spread over the top of the powder bed. The process can then be repeated to form additional layers of the anti-glare diffusion film.

In further examples, for individual layers of the 3D printed anti-glare diffusion film, a thin layer of polymer powder can be spread on a bed to form a powder bed. At the beginning of the process, the powder bed can be empty because no polymer particles have been spread at that point. For the first layer, the polymer particles can be spread onto an empty build platform. The build platform can be a flat surface made of a material sufficient to withstand the heating conditions of the 3D printing process, such as a metal. Thus, “applying individual build material layers of polymer particles to a powder bed” includes spreading polymer particles onto the empty build platform for the first layer. In other examples, a number of initial layers of polymer powder can be spread before the printing begins. These “blank” layers of powder bed material can in some examples number from about 10 to about 500, from about 10 to about 200, or from about 10 to about 100. In some cases, spreading multiple layers of powder before beginning the print can increase temperature uniformity of the 3D printed article. A printing head, such as an inkjet print head, can then be used to print a fusing agent over portions of the powder bed corresponding to a thin layer of the 3D article to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polymer powder can be spread over the powder bed and the process can be repeated to form additional layers until a complete 3D printed anti-glare diffusion film is printed. Thus, “applying individual build material layers of polymer particles to a powder bed” also includes spreading layers of polymer particles over the loose particles and fused layers beneath the new layer of polymer particles.

3D printing systems used to perform these printing methods can include an electromagnetic energy source to apply electromagnetic energy to fuse the polymer powder printed with the fusing agent. In some cases, the energy source can be a lamp such as an infrared lamp.

Suitable fusing lamps for use in the 3D printing system can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure used to fuse individual printed layers. The fusing lamp can be configured to irradiate the entire powder bed with a substantially uniform amount of energy. This can selectively fuse the portions printed with the fusing agent while leaving the unprinted portions of the polymer powder below the fusing temperature.

In some examples, the three-dimensional printing system can also include preheaters for preheating the polymer powder to a temperature near the fusing temperature. In one example, the system can include a print bed heater to heat the print bed during printing. The preheat temperature used can depend on the type of polymer used. In some examples, the print bed heater can heat the print bed to a temperature from about 50° C. to about 250° C. The system can also include a supply bed, where polymer particles can be stored before being spread in a layer onto the print bed. The supply bed can have a supply bed heater. In some examples, the supply bed heater can heat the supply bed to a temperature from about 80° C. to about 180° C.

Depending on the amount of radiation absorber present in the polymer powder, the absorbance of the radiation absorber, the preheat temperature, and the fusing temperature of the polymer, an appropriate amount of irradiation can be supplied from the electromagnetic energy source or fusing lamp. In some examples, the fusing lamp can irradiate individual layers from about 0.1 to about 10 seconds per pass. In further examples, the fusing lamp can move across the powder bed at a rate of about 1 inch per second to about 60 inches per second to fuse the layers. In still further examples, the fusing lamp can move across the powder bed at a rate of about 5 inches per second to about 20 inches per second.

### Powder Bed Materials

The powder bed material used to make the anti-glare diffusion films described herein can be a thermoplastic transparent polymer. Thus, the transparent polymer particles can coalesce when printed with the fusing agent and heated using an electromagnetic energy source. In certain examples, the transparent polymer particles can include polyethylene terephthalate, polyethylene naphthalate, polycarbonate, polyethersulfone, polycyclic olefin, polyimide, polarylate, polymethyl methacrylate, copolymers thereof, or combinations thereof. In further examples, the transparent polymer particles can have a refractive index from about 1.4 to about 1.7.

In further examples, the powder bed material can include polymer particles having a variety of shapes, such as substantially spherical particles or irregularly-shaped particles. In some examples, the polymer powder can be capable of being formed into 3D printed parts with a resolution of about 20 μm to about 100 μm, about 30 μm to about 90 μm, or about 40 μm to about 80 μm. As used herein, “resolution” refers to the size of the smallest feature that can be formed on a 3D printed part. The polymer powder can form layers from about 20 μm to about 100 μm thick, from about 30 μm to about 90 μm thick, or from about 40 μm to about 80 μm thick, allowing the fused layers of the printed part to have roughly the same thickness. This can provide a resolution in the z-axis (i.e., depth) direction of about 20 μm to about 100 μm, about 30 μm to about 90 μm, or about 40 μm to about 80 μm, for example. The polymer powder can also have a sufficiently small particle size and sufficiently regular particle shape to provide about 20 μm to about 100 μm resolution along the x-axis and y-axis (i.e., the axes parallel to the top surface of the powder bed). For example, the polymer powder can have a D50 particle size from about 20 μm to about 100 μm. In other examples, the D50 particle size can be from about 20 μm to about 50 μm. Other resolutions along these axes can be from about 30 μm to about 90 μm, or from 40 μm to about 80 μm. “D50 particle size” is defined as the particle size at which about half of the particles are larger than the D50 particle size and about half of the other particles are smaller than the D50 particle size (this value can be based on weight). As used herein, particle size refers to the value of the diameter of spherical particles. If a particle is not uniformly spherical, an average diameter can be used.

The thermoplastic polymer powder can have a melting or softening point from about 70° C. to about 350° C. In further examples, the polymer can have a melting or softening point from about 150° C. to about 200° C. A variety of thermoplastic polymers with melting points or softening points in these ranges can be used. For example, the polymer powder can be nylon 6 powder, nylon 9 powder, nylon 11 powder, nylon 12 powder, nylon 66 powder, nylon 612 powder, polyethylene powder, wax, thermoplastic polyurethane powder, acrylonitrile butadiene styrene powder, amorphous polyamide powder, polymethylmethacrylate powder, ethylene-vinyl acetate powder, polyarylate powder, silicone rubber, polypropylene powder, polyester powder, polycarbonate powder, copolymers of polycarbonate with acrylonitrile butadiene styrene, copolymers of polycarbonate with polyethylene terephthalate polyether ketone powder, polyacrylate powder, polystyrene powder, or mixtures thereof.

The thermoplastic polymer particles can also in some cases be blended with a filler. The filler can include inorganic particles such as alumina, silica, or combinations thereof. When the thermoplastic polymer particles fuse together, the filler particles can become embedded in the polymer, forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In some examples, a weight ratio of thermoplastic polymer particles to filler particles can be from about 10:1 to about 1:2 or from about 5:1 to about 1:1.

### Fusing Agents

The 3D printing kits described herein can include a fusing agent(s) that include an agent liquid vehicle, e.g., water, organic co-solvent, surfactant, etc., that carry diffusing particles, for example. Thus, the fusing agent is a fluidic dispersion. Again, the hollow glass beads, hollow polymer beads, and titanium aerogel particles can collectively be referred to as diffusing particles. In some examples, the diffusing particles can be present in the fusing agent in an amount from about 3 wt % to about 30 wt % based on the total weight of the fusing agent. In further examples, the amount of diffusing particles can be from about 5 wt % to about 25 wt %, or from about 7 wt % to about 20 wt %, based on the total weight of the fusing agent. When the fusing agent is printed onto the layers of transparent polymer particles and then the layers are fused to form the anti-glare diffusing film, the total concentration of diffusing particles in the transparent polymer film can be sufficient to reduce glare by diffusing light reflected off the film. In certain examples, the concentration of diffusing particles in the final anti-glare diffusing film can be from about 0.1 wt % to about 3 wt % based on a total weight of the anti-glare diffusing film. In other examples, the diffusing particles can be present at from about 0.2 wt % to about 3 wt %, from about 0.3 wt % to about 3 wt %, from about 0.4 wt % to about 2.5 wt %, from about 0.5 wt % to about 2.5 wt %, from about 0.5 wt % to about 2 wt %, from about 0.75 wt % to about 2 wt %, from about 1 wt % to about 2.5 wt %, or from about 1 wt % to about 2 wt %, based on the total weight of the anti-glare diffusing film.

In some examples the diffusing particles can be hollow glass beads or hollow polymer beads. These can include an outer shell and an inner hollow portion. The inner hollow portion can include air, which has a refractive index of about 1 at standard temperature and pressure (0° C. and 760 mmHg). The outer shell can include a glass or polymer material that is considered to be an optical polymer or glass so that it is transparent or nearly transparent, at the same time having a refractive index that is different enough from the air that it can provide light scattering. Example materials that can be used in this regard include, for example, polyacrylic, e.g., polymethyl methacrylate (PMMA); polycarbonate; cyclic olefin copolymer (COO); cyclic olefin polymer (COP); polystyrene; polyetherimide; glass; etc. Other materials can also be used for the hollow bead diffusing particles, such as other optical materials that have a refractive index different enough from air to provide light scattering. In a particular example, the diffusing particles can be ROPAQUE™ AF-1055 ER hollow sphere styrene acrylic beads (Dow Chemical Company, Michigan).

In other examples, the diffusing particles can be titanium aerogel particles. In some examples, the titanium aerogel particles can include titanium oxide having a density from about 0.03 g/cm³ to about 0.75 g/cm³. Titanium oxide aerogel can be prepared by the sol-gel process and dried under supercritical conditions.

The particle size of the diffusing particles, as well as the size of the inner dimension of the outer shell (defining the hollow inner portion or air pocket) in hollow bead diffusing particles, can be considered to promote light scattering. If the particle size is too small, or if the inner dimension of the hollow beads is too small, then the diffusing particles may be optically less effective at scattering light. Good scattering can occur when the particle size is about half the wavelength of the light, which may be the visible light spectrum. As the visible light range is from about 380 nm to about 750 nm, hollow optical nanospheres with a D50 particle size from about 50 nm to about 1.25 μm can be effective for scattering light. Other particle size ranges can be from about 100 nm to about 1 μm, from about 150 nm to about 750 nm, from about 200 nm to about 700 nm, from about 250 nm to about 600 nm, from about 150 nm to about 500 nm, or from about 200 nm to about 500 nm. Below about 50 nm, visible light scattering is less effective, for example. In further detail for the hollow beads, the inner size or dimension of the outer shell, e.g., average inner diameter or average length across the air pocket, can be from about 60 nm to about 750 nm, from about 100 nm to about 500 nm, or from about 150 nm to about 300 nm. As mentioned, the “D50” particle size is defined as the particle size at which about half of the particles are larger than the D50 particle size and about half of the other particles are smaller than the D50 particle size (this value can be based on weight), based on diameter of spherical particles or an average diameter if not spherical. The same is true when determining the D50 value of the inner dimension of the outer shell of the hollow glass beads or hollow polymer beads.

As mentioned above, a compound(s) in the fusing agent may absorb radiant energy and convert the energy to heat to heat up the powder bed material. In some examples, the diffusing particles themselves can absorb radiation and convert the energy to heat. In other examples, the fusing agent can include an additional radiation absorber to absorb radiation energy and convert the energy to heat. In certain examples, the fusing agent can include a colorless radiation absorber, or a colored radiation absorber can be included in a sufficiently low amount that no visible color is imparted to the anti-glare diffusing films. In various examples, the radiation absorber can be glass fiber, titanium dioxide, clay, mica, talc, barium sulfate, calcium carbonate, a near-infrared absorbing dye, a near-infrared absorbing pigment, a dispersant, a conjugated polymer, a dispersant, or combinations thereof. Examples of near-infrared absorbing dyes include aminium dyes, tetraaryldiamine dyes, cyanine dyes, pthalocyanine dyes, dithiolene dyes, and others. In further examples, the fusing compound can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range from about 700 nm to about 1500 nm, from about 800 nm to about 1400 nm, or from about 900 nm to about 1300 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si2O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable near-infrared pigments.

A dispersant can be included in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is printed onto the polymer powder, the amount of radiation absorber in the polymer powder can be from about 0.0003 wt % to about 10 wt %, or from about 0.005 wt % to about 5 wt %, with respect to the weight of the polymer powder.

### Detailing Agents

The detailing agent can include a detailing compound capable of cooling the polymer powder in portions of the powder bed onto which the detailing agent is printed. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

In some examples, the detailing compound can be a solvent that evaporates at the temperature of the powder bed. Thus, in some examples, the detailing compound is the detailing agent, e.g., 100 wt % solvent detailing agent is also the detailing compound. In other cases, the detailing agent includes a liquid vehicle that carries a detailing compound. In further detail, the powder bed can be preheated to a preheat temperature within about 10° C. to about 70° C. of the fusing temperature of the polymer powder. Depending on the type of polymer powder used, the preheat temperature can be in the range of about 90° C. to about 200° C. or more. Thus, the detailing compound can be a solvent that evaporates when it comes into contact with the powder bed at the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl Ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof. In some examples, the detailing agent can be mostly water. In a particular example, the detailing agent can be about 85 wt % to 100 wt % water, from 90 wt % to 100 wt % water, from 95 wt % to 100 wt % water, from 85 wt % to 99.9 wt % water, from 90 wt % to 99.9 wt % water, or from 95 to 99.9 wt % water. In cases where there is 100 wt % water, the detailing agent and the detailing compound are both water. However, if there is less than 100 wt % water, then another compound and/or water can act as the detailing compound in the detailing agent formulation. In still further examples, the detailing agent can be substantially devoid of radiation absorbers. That is, in some examples, the detailing agent can be substantially devoid of ingredients that absorb enough energy from the light source to cause the powder to fuse. In certain examples, the detailing agent can include colorants such as dyes or pigments, but in small enough amounts that the colorants do not cause the powder printed with the detailing agent to fuse when exposed to the light source.

The components of the above described fluids, e.g., fusing agents, activator agents, co-activator agents, and detailing agents, can be selected to give the respective agents/fluids good fluid jetting performance and the ability to fuse the polymer bed material. Thus, these agents/fluids can include a liquid vehicle. In some examples, the liquid vehicle formulation can include a co-solvent or co-solvents present in total at from about 1 wt % to about 50 wt %, depending on the jetting architecture. Further, a non-ionic, cationic, and/or anionic surfactant can be present, ranging from about 0.01 wt % to about 10 wt %, or from about 0.1 wt % to about 7.5 wt %. In one example, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, material for pH adjustment, sequestering agents, preservatives, and the like. In one example, the liquid vehicle can be predominantly water.

In some examples, a water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the agents/fluids can be substantially free of organic solvent, e.g., predominantly water. However, in other examples a co-solvent can be used to help disperse other dyes or pigments, or enhance the jetting properties of the respective agents/fluids. In still further examples, a non-aqueous vehicle can be used with an organic-soluble or organic-dispersible fusing compound to form the fusing agent.

In certain examples, a high boiling point co-solvent can be included in the various agents/fluids. The high boiling point co-solvent can be an organic co-solvent that boils at a temperature higher than the temperature of the powder bed during printing. The high boiling point co-solvent can be defined as having a boiling point above about 250° C. In still further examples, the high boiling point co-solvent can be present in the various agents/fluids at a concentration from 0.5 wt % to about 10 wt %, from about 1 wt % to about 7 wt %, or from about 1 wt % to about 4 wt %.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the formulation of this disclosure may range from about 0.01 wt % to about 3 wt %. Suitable surfactants can include, but are not limited to, liponic esters such as Tergitol™ 15-S-12, Tergitol™ 15-S-7 available from Dow Chemical Company (Michigan), LEG-1 and LEG-7; Triton™ X-100; Triton™ X-405 available from Dow Chemical Company (Michigan); and sodium dodecylsulfate.

Consistent with the formulations of this disclosure, as mentioned, various other additives can be employed to enhance certain properties of the agent/fluid compositions for specific applications. Examples of these additives are those added to inhibit the growth of harmful microorganisms. These additives may be biocides, fungicides, and other microbial agents, which can be used in various agent formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), and combinations thereof.

Sequestering agents, such as EDTA (ethylene diamine tetra acetic acid), may be included to eliminate the deleterious effects of heavy metal impurities, and buffer solutions may be used to control the pH of the agent/fluid. From about 0.01 wt % to about 2 wt %, for example, can be used. Viscosity modifiers and buffers may also be present, as well as other additives to modify properties of the agents/fluids as desired. Such additives can be present at from about 0.01 wt % to about 20 wt %

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 5% or other reasonable added range breadth of a stated value or of a stated limit of a range. The term “about” when modifying a numerical range is also understood to include the exact numerical value indicated, e.g., the range of about 1 wt % to about 5 wt % includes 1 wt % to 5 wt % as an explicitly supported sub-range.

As used herein, “liquid vehicle” refers to a liquid in a fusing agent, detailing agent, etc. A wide variety of liquid vehicles may be used with the systems and methods of the present disclosure. Such liquid vehicles may include a mixture of a variety of different agents, including, surfactants, solvents, co-solvents, anti-kogation agents, buffers, biocides, sequestering agents, viscosity modifiers, surface-active agents, water, etc.

As used herein, “colorant” can include dyes and/or pigments.

As used herein, “dye” refers to compounds or molecules that absorb electromagnetic radiation or certain wavelengths thereof. Dyes can impart a visible color to a fluidic agent if the dyes absorb wavelengths in the visible spectrum.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe pigment colorants and other pigments such as organometallics, ferrites, ceramics, etc. In one specific example, however, the pigment is a pigment colorant.

As used herein, a plurality of items, structural elements, compositional elements, and/or materials may be presented in a common list for convenience. However, these lists should be construed as though the individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if individual numerical values and sub-ranges are explicitly recited. For example, a layer thickness from about 0.1 μm to about 0.5 μm should be interpreted to include the explicitly recited limits of 0.1 μm to 0.5 μm, and to include thicknesses such as about 0.1 μm and about 0.5 μm, as well as subranges such as about 0.2 μm to about 0.4 μm, about 0.2 μm to about 0.5 μm, about 0.1 μm to about 0.4 μm etc.

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### EXAMPLE

An example anti-glare diffusing film is made as follows:
1) A HP Multi Jet Fusion 3D® printer is loaded with polyethylene terephthalate powder as the powder bed material. The fusing agent printhead is loaded with a fusing agent that includes 5 wt % hollow polyacrylic beads. The detailing agent printhead is loaded with water.
2) The 3D printer jets the fusing agent onto a rectangular area having the dimensions of a 15 inch diagonal laptop monitor.
3) The 3D printer jets the detailing agent around the edges of the area printed with the fusing agent.
4) The 3D printer passes a halogen lamp over the powder bed, fusing the powder particles printed with the fusing agent.
5) A new layer of polyethylene terephthalate powder is spread over the powder bed and the process is repeated to form additional solid layers until the anti-glare diffusing film has a thickness of about 300 μm.
6) The anti-glare diffusing film is removed from the 3D printer and an optically clear adhesive is applied to a surface of the anti-glare diffusing film.
7) The anti-glare diffusing film is either adhered immediately to a laptop monitor or a release film is applied to the adhesive layer so that the anti-glare diffusing film can be adhered to a monitor at a later time.

What is claimed is:

1. An anti-glare diffusing film for an electronic display comprising multiple fused layers which individually include transparent polymer particles fused together using a fusing agent, wherein the fusing agent includes diffusing particles selected from hollow glass beads, hollow polymer beads, titanium aerogel particles, or a combination thereof.

2. The anti-glare diffusing film of claim 1, wherein the anti-glare diffusing film has a thickness from about 50 μm to about 500 μm.

3. The anti-glare diffusing film of claim 1, wherein the transparent polymer particles comprise polyethylene terephthalate, polyethylene naphthalate, polycarbonate, polyethersulfone, polycyclic olefin, polyimide, polarylate, polymethyl methacrylate, copolymers thereof, or combinations thereof.

4. The anti-glare diffusing film of claim 1, wherein individual fused layers include a relatively higher concentration of the diffusing particles in a top portion of the individual fused layers and a relatively lower concentration of the diffusing particles in a bottom portion of the individual fused layers.

5. The anti-glare diffusing film of claim 1, wherein a concentration of the diffusing particles is uniform across the anti-glare diffusing film.

6. The anti-glare diffusing film of claim 1, wherein a concentration of the diffusing particles is higher in an area to be located over a relative bright spot in the electronic display and lower in an area to be located over a relative dark spot in the electronic display.

7. An electronic display comprising:
a display panel;
an optically clear adhesive layer over the display panel; and
an anti-glare diffusing film over the adhesive layer wherein the anti-glare diffusing film comprises multiple fused layers which individually include transparent polymer particles fused together using a fusing agent, wherein the fusing agent comprises diffusing particles selected from hollow glass beads, hollow polymer beads, titanium aerogel particles, or a combination thereof.

8. The electronic display of claim 7, wherein the display panel is a liquid crystal display (LCD) panel, a light emitting diode (LED) panel, or an organic light emitting diode (OLED) panel.

9. The electronic display of claim 7, further comprising a backlight unit having a relative bright spot of illumination, and wherein a concentration of the diffusing particles in the anti-glare diffusing film is higher in an area over the bright spot compared to other areas of the anti-glare diffusing film that are relatively darker in illumination.

10. The electronic display of claim 7, further comprising a touch sensor layer over the display panel and below the anti-glare diffusing film.

11. The electronic display of claim 7, wherein the transparent polymer particles comprise polyethylene terephthalate, polyethylene naphthalate, polycarbonate, polyethersulfone, polycyclic olefin, polyimide, polarylate, polymethyl methacrylate, copolymers thereof, or combinations thereof

12. A 3D printing kit comprising:
a powder bed material comprising transparent polymer particles;
a fusing agent to apply to the powder bed material, the fusing agent comprising diffusing particles selected from hollow glass beads, hollow polymer beads, titanium aerogel particles, or a combination thereof.

13. The 3D printing kit of claim 12, wherein the transparent polymer particles comprise polyethylene terephthalate, polyethylene naphthalate, polycarbonate, polyethersulfone, polycyclic olefin, polyimide, polarylate, polymethyl methacrylate, copolymers thereof, or combinations thereof.

14. The 3D printing kit of claim 12, further comprising a detailing agent including a fluid vehicle and a separate detailing compound.

15. The 3D printing kit of claim 12, wherein the fusing agent further comprises a colorless infrared absorbing compound.
